(19) United States
(12) Patent Application Publication
(10) Pub. No.: US 2018/0174004 A1
(43) Pub. Date: Jun. 21, 2018

(54) IMAGE FORMING APPARATUS AND PAPER FEED CONTROL METHOD

(71) Applicant: CANON KABUSHIKI KAISHA, Tokyo (JP)

(72) Inventor: Takeshi Kaneda, Funabashi-shi (JP)

(21) Appl. No.: 15/832,821

(22) Filed: Dec. 6, 2017

(30) Foreign Application Priority Data
Dec. 21, 2016 (JP) 2016-247845

(51) Int. Cl. G06K 15/02; H04N 1/00; G06K 15/00

(52) U.S. Cl. CPC G06K 15/1813; H04N 1/00915; G06K 15/021; G06K 15/1836; G06K 15/4065; H04N 2201/0094; G06K 2215/0097; G06K 15/1823

(57) ABSTRACT

The image forming apparatus of the present invention is an image forming apparatus capable of performing, in accordance with reception of print data from an external device, image formation for a sheet that is set in a specific sheet set unit by using sheet attribute information added to the received print data without using sheet attribute information associated in advance with the specific sheet set unit, the image forming apparatus including: one or more controllers including at least one processor or at least one circuit including a function, the one or more controllers being configured to function as: a unit configured to prevent image formation in accordance with reception of print data from being performed based on that sheet attribute information added to the print data received from the external device is specific sheet attribute information.

### BACKGROUND OF THE INVENTION

### Field of the Invention

The present invention relates to an image forming apparatus and a paper feed control method.

### Description of the Related Art

Conventionally, in the case where printing is performed from a paper feed tray, for example, such as a manual feed tray, in an image forming apparatus, the image forming apparatus detects a sheet arranged on the tray by a user by a paper sensor on the tray and displays a UI screen on which to select the sheet size, the sheet type, and the paper feed direction of the arranged sheet. In the conventional image forming apparatus, it is possible to securely acquire information relating to a sheet arranged on the tray by the setting of a user, but each time the sheet on the tray runs out, it is necessary for a user to set information relating to the sheet, and therefore, there is such a problem that this is troublesome for a user.

In order to avoid this problem in advance, an image forming apparatus is known, which includes “PDL data prioritized mode (that is, mode in which priority is given to print data)” (Japanese Patent Laid-Open No. 2012-123728). In this image forming apparatus, by acquiring information relating to “paper feed tray” and information relating to “sheet size/sheet type” of a sheet that is fed from a document attribute and a page attribute described in page description languages (PDLs) and the like within print data, the input by a user on the UI screen is omitted.

However, in the case where the sheet size, the sheet type, and the paper feed tray of a sheet that is fed are determined from PDL data, on a condition that information necessary for paper feed is not sufficient within the PDL data, the image forming apparatus performs paper feed processing in the state of not recognizing the information relating to the sheet. That is, the image forming apparatus performs printing processing by feeding a sheet different from the sheet intended by a user, and therefore, there is a possibility that printing fails in some cases.

The present invention has been made in view of the above-described conventional problem and an object thereof is to prevent printing from failing in the case where a mode in which printing is performed by giving priority to print data even though information necessary for paper feed is not sufficient within the print data.

### SUMMARY OF THE INVENTION

In order to attain the above-described object, the image forming apparatus of the present invention is an image forming apparatus capable of performing, in accordance with reception of print data from an external device, image formation for a sheet that is set in a specific sheet set unit by using sheet attribute information added to the received print data without using sheet attribute information associated in advance with the specific sheet set unit, the image forming apparatus including: one or more controllers including at least one processor or at least one circuit including a function, the one or more controllers being configured to function as: a unit configured to prevent image formation in accordance with reception of print data from being performed based on that sheet attribute information added to the print data received from the external device is specific sheet attribute information.

Further features of the present invention will become apparent from the following description of exemplary embodiments with reference to the attached drawings.

### BRIEF DESCRIPTION OF THE DRAWINGS

FIG. 1 is a configuration diagram of a printing processing system;

FIG. 2 is a hardware configuration diagram of an image forming apparatus;

FIG. 3 is a software configuration diagram of the image forming apparatus;

FIG. 4 is a diagram showing a relationship between FIGS. 4A and 4B;

FIGS. 4A and 4B are flowcharts showing processing relating to paper feed and printing control of the image forming apparatus;

FIG. 5 is a diagram showing index paper that is fed to the image forming apparatus and setting thereof;

FIG. 6 is a diagram showing an envelope that is fed to the image forming apparatus and setting thereof;

FIG. 7 is a diagram showing a cancel screen of printing processing at the time of “PDL data prioritized mode” setting;

FIG. 8 is a diagram showing setting examples of a user on a paper feed setting screen of an information processing apparatus;

FIG. 9 is a diagram showing paper feed setting screens in the image forming apparatus;

FIG. 10 is a paper feed setting screen in the information processing apparatus; and

FIG. 11A and FIG. 11B are each a diagram showing a paper feed tray structure of the image forming apparatus.

### DESCRIPTION OF THE EMBODIMENTS

First, before explaining an embodiment of the present invention, the target of the present invention is explained specifically and in detail by using the drawings relating to a screen on which to set paper feed information on an image forming apparatus, a printing setting screen on which to generate print data in an information processing apparatus, and a paper feed tray structure of the image forming apparatus.

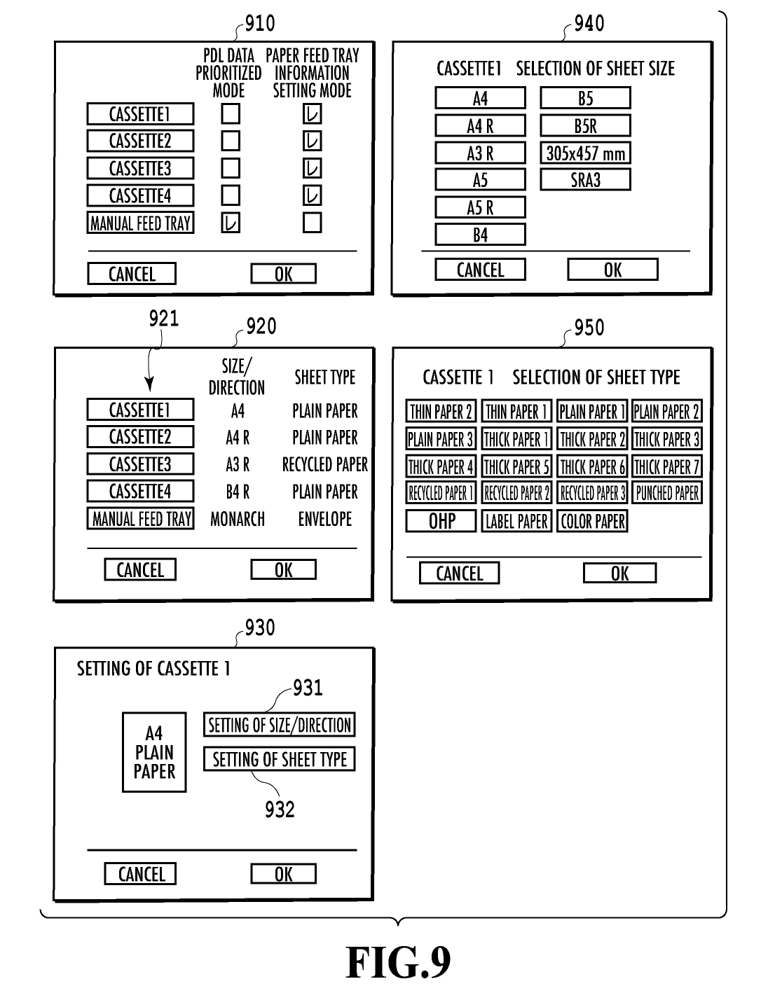

FIG. 9 is UI (User Interface) screens on which to perform paper feed setting of a paper feed tray in an image forming apparatus. A setting screen 910 is a screen on which to select an operating mode of each paper feed tray and a user selects “PDL data prioritized mode” or “paper feed tray information setting mode” for each paper feed tray. A setting screen 920 is a screen on which to select a paper feed tray, which is a target of setting, at the time of setting “sheet size”, “paper feed direction”, and “sheet type” for each paper feed tray. A setting screen 930 is a screen that is displayed in the case where a paper feed tray (for example, cassette 1 (921)) is selected on the setting screen 920 and is a screen on which to select one of “sheet size/paper feed direction” (931) and “sheet type” (932), which is set for the paper feed tray. A setting screen 940 is a screen that is displayed in the case where “sheet size/paper feed direction” (931) is selected on the setting screen 930 and a user selects desired “sheet size/paper feed direction” on the setting screen 940. A setting screen 950 is a screen that is displayed in the case where “sheet type” (932) is selected on the setting screen 930 and a user selects desired “sheet type” on the setting screen 950. In the case where “PDL data prioritized mode” is selected on the setting screen 910, the setting screens (920, 930, 940, 950) are not displayed in the image forming apparatus.

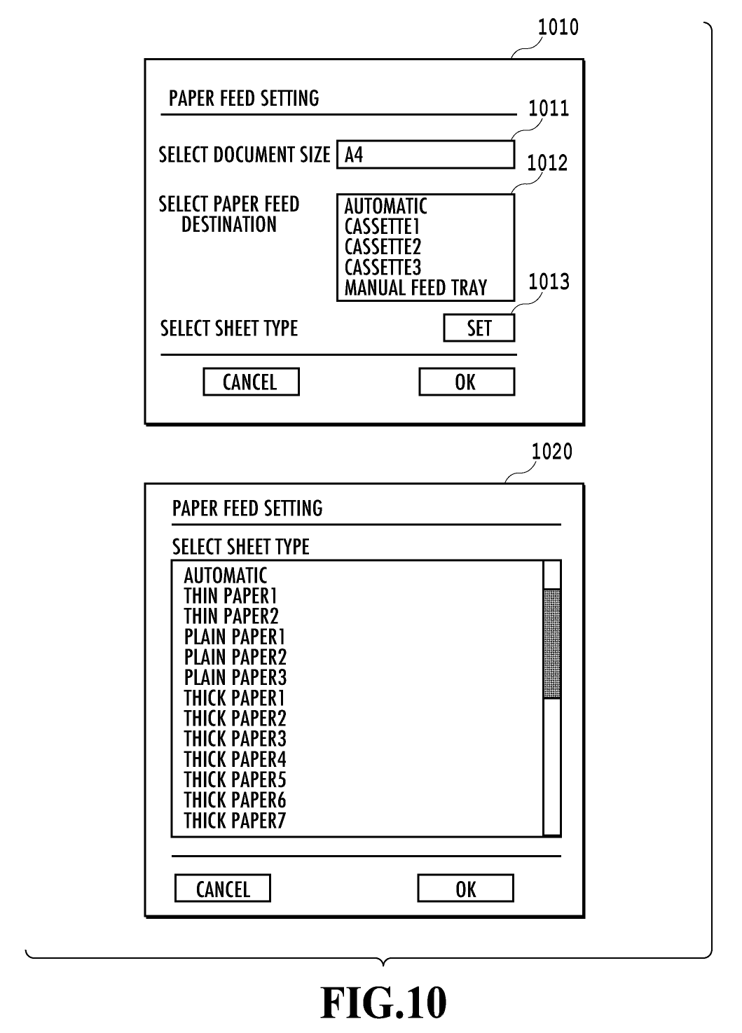

FIG. 10 is a paper feed setting screen in an information processing apparatus and shows a paper feed setting screen of a print driver in the information processing apparatus, for example, such as a host PC (Personal Computer). A setting screen 1010 is a screen on which to set paper feed and it is possible for a user to set a sheet size 1011, a paper feed destination 1012, and a sheet type 1013 on the setting screen 1010. A setting screen 1020 is displayed in the case where the setting of the sheet type 1013 is selected on the setting screen 1010 and it is possible for a user to select the sheet type on the setting screen 1020.

Here, in the case where “PDL data prioritized mode” is selected for a certain paper feed tray, the setting screens (920, 930, 940, 950) are not displayed in the image forming apparatus as described previously. That is, in this case, even though a user arranges a sheet on that paper feed tray, the setting screens shown in FIG. 9 are not displayed, that is, information relating to the sheet is not set by a user, and therefore, it is not possible for the image forming apparatus to recognize information relating to the sheet arranged on the paper feed tray.

Further, on the paper feed setting screen in FIG. 10, in the case where the sheet size 1011 and/or the sheet type 1013 is not set by a user, the image forming apparatus receives data for which the sheet size and/or the sheet type is not specified as a result. In this case, on a condition that a paper feed tray for which “PDL data prioritized mode” is set is selected, the image forming apparatus performs the paper feed processing as it is in the state of not recognizing the information relating to the sheet, and therefore, there is a possibility that a sheet different from the sheet intended by a user is fed. For example, even though a user plans to perform printing on plain paper, in the case where special paper is arranged on the paper feed tray for which “PDL data prioritized mode” is set and the image forming apparatus has not recognized information on the sheet, the image forming apparatus feeds the special paper because of not being capable of recognizing the special paper.

In addition, in the paper feed control of special paper, such as index paper and an envelope, there is a case where supplementary information is necessary in addition to the three parameters, that is, “sheet size”, “sheet type”, and “paper feed tray”, in order to prevent printing from failing. In the following, this point is supplemented by using the drawings relating to the paper feed tray structure of the image forming apparatus by mainly taking an envelope as an example.

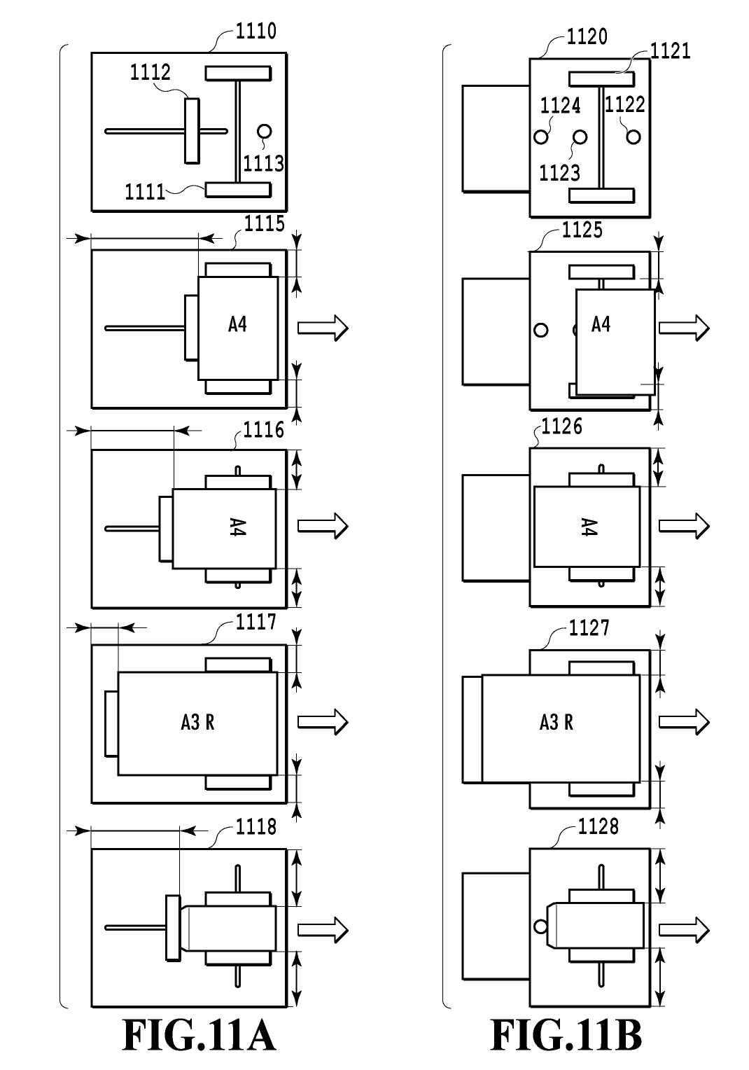

FIGS. 11A and 11B are each a diagram showing a paper feed tray structure of the image forming apparatus. In FIG. 11A and FIG. 11B, FIG. 11A shows the structure of a cassette and FIG. 11B shows the structure of a manual feed tray, respectively. A cassette 1110 includes a guide 1111 to detect a main scan width and a guide 1112 to detect a sub scan width as guides of a sheet, and further includes a sensor 1113 to detect that a sheet is arranged on the paper feed tray. In the case of detecting that a sheet is arranged within the cassette by the sensor 113, the cassette 1110 causes the guide 1111 and the guide 1112 to function as a width detection unit and determines a rough size of the arranged sheet.

Further, a paper feed example 1115 shows an example in which an A4 sheet is fed from the long side (297 mm), a paper feed example 1116 shows an example in which an A4 sheet is fed from the short side (210 mm), and a paper feed example 1117 shows an example in which an A3 sheet is fed from the short side (297 mm), respectively. Further, a paper feed example 1118 shows an example in which an envelope is fed.

Here, the guide 1111 and the guide 1112 of the cassette 1110 are caused to have a structure of being slid both in the width direction and in the height direction, and therefore, it is possible for the image forming apparatus to detect the width of the arranged sheet in units of several millimeters. Consequently, it is possible for the image forming apparatus to determine that different sheets are arranged in the case where an A4 sheet is arranged (1115, 1116), in the case where an A3 sheet is arranged (1117), and in the case where an envelope is arranged (1118).

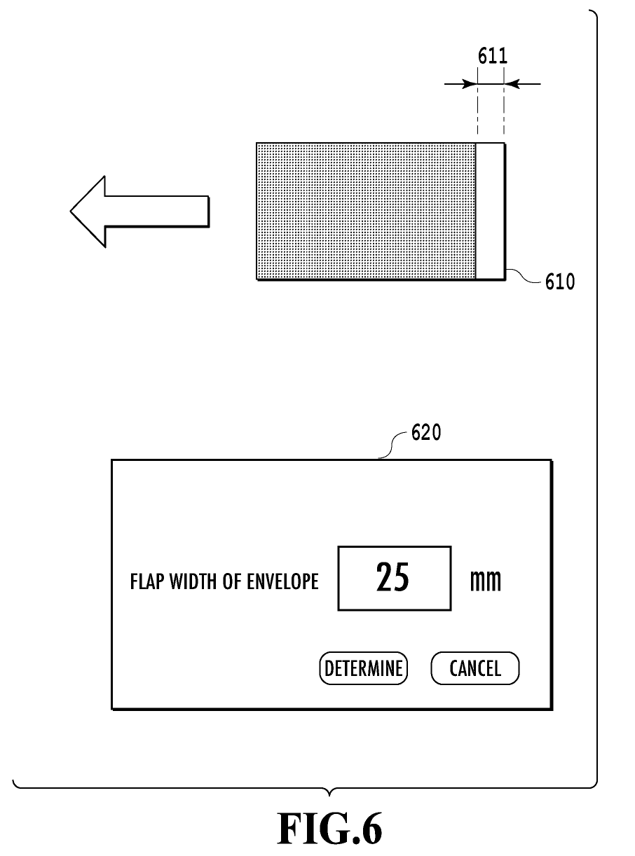

However, as to an envelope, the length of the flap width (611 in FIG. 6, to be described later) is not normalized and the length of the flap width is different for different envelopes. Further, in the case where an envelope is arranged within the cassette, as described previously, it is possible for the image forming apparatus to determine the size of the sheet (envelope) including the flap width by two of the guide 1111 and the guide 1112, but not possible to further measure the length of the flap width.

In this situation, in the case where a user plans to perform printing on the flap width of the envelope in the paper feed tray information setting mode, the user sets the flap width of the envelope in the image forming apparatus before performing printing processing. However, in the case where a user does not plan to perform printing on the flap width and the cassette is set to “PDL data prioritized mode”, the setting screen is not displayed and normally, the flap width is not set by a user in the image forming apparatus. Because of this, in the case where the cassette is set to “PDL data prioritized mode”, the image forming apparatus performs printing processing in the state where the flap width is not recognized (that is, in the state where the flap width is added to the sheet size). That is, printing processing is performed in the state where the sheet size including the flap width detected by a conveyance sensor and the image size of the print data not including the flap width do not coincide with each other, and as a result, there is a possibility that a jam is erroneously detected in the conveyance control or printing fails.

Next, a manual feed tray 1120 is explained. The manual feed tray 1120 includes a guide 1121 that detects a main scan width as a guide of a sheet and further includes width detection sensors 1122, 1123, and 1124 that detect a sub scan width. The manual feed tray 1120 causes the guide 1121 and the width detection sensors 1122, 1123, and 1124 to function as a width detection unit and determines a rough size of the arranged sheet.

A paper feed example 1125 shows an example in which an A4 sheet is fed from the long side (297 mm), a paper feed example 1126 shows an example in which an A4 sheet is fed from the short side (210 mm), a paper feed example 1127 shows an example in which an A3 sheet is fed from the short side (297 mm), respectively. Further, a paper feed example 1128 shows an example in which an envelope is fed.

Here, as described previously, the manual feed tray 1120 includes only the three width detection sensors that detect a sub scan width. Because of this, in the case where a sheet arranged on the manual feed tray 1120 has a difference as large as that between an A3 sheet of standard size and an A4 size of standard size, it is possible to detect the difference from the signal of the width detection sensor 1124, but in the case where the sub scan width differs in units of several millimeters, it is not possible to detect the difference.

In this situation, in the case where information on the width and height of the image size of the print data does not coincide with information on the width and height detected by the width detection sensors (1121, 1122, 1123, 1124), in a paper feed information setting mode, it is determined that the sizes do not coincide with each other, and therefore, the paper feed processing is not performed. However, in “PDL data prioritized mode”, the image forming apparatus performs the paper feed operation by giving priority to the information on the PDL data for each of the sheet size and the sheet type. Because of this, for special paper (the envelope (1128) and the like), which has a difference between the sheet size in the print data and the sheet size of the sheet that is fed, unless a user corrects the parameter in the sub scan direction, the difference cannot be detected and in the paper feed control, there is a possibility that an error, such as a jam, occurs.

Further, as to the paper feed and printing of index paper, on one hand, the print data is the size including the index portion, but on the other hand, the sheet that is fed takes the standard size, such as A4 and LTR, as a reference. Because of this, it is necessary for the image forming apparatus to perform paper feed only in the case where the image size of the print data and the sheet size that adds the width and height of the index portion coincide with each other at the time of paper feed control. However, in “PDL data prioritized mode”, information relating to the width and height of the index portion of the sheet that is fed is lost in the print data, and therefore, in the case where the print data and the sheet size do not coincide with each other, there is a possibility that trouble, such as a jam, and a printing failure occur.

As above, in “PDL data prioritized mode”, in the case where it is not possible to acquire the parameters necessary for the paper feed control from the print data, in order to prevent printing from failing, it is necessary to prevent the image forming apparatus from operating in “PDL data prioritized mode” or to cause the image forming apparatus to operate after supplementing lacking information. In the following, with this point in mind, the embodiment of the present invention is explained in detail with reference to the drawings. The following embodiment is not intended to limit the invention according to the scope of the claims and all the combinations of the features explained in the embodiment are not necessarily indispensable for the solution of the invention.

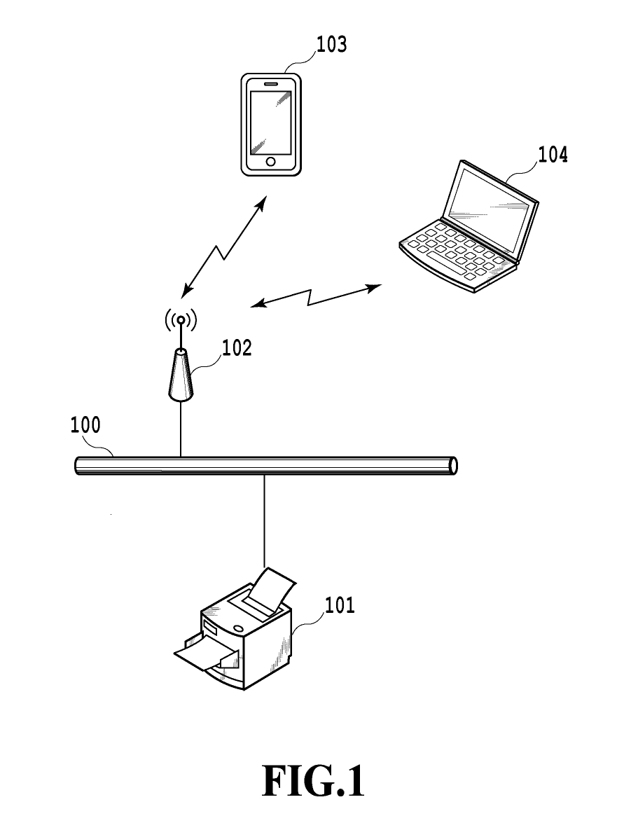

FIG. 1 is a block diagram showing a printing processing system according to the embodiment of the present invention. As shown in FIG. 1, on a LAN (Local Area Network) 100, an MFP (Multifunction Peripheral) 101 and an AP (Access Point) 102 are connected to each other so as to be capable of communication.

In the present embodiment, as a printing apparatus, the image forming apparatus 101 is explained as an example thereof. The image forming apparatus 101 has a printing function to print an image on a sheet and performs printing processing based on print data received via a network. Further, as an information processing apparatus, a mobile terminal 103 and a PC (Personal Computer) 104 are explained as examples thereof. It is possible for the information processing apparatus, such as the mobile terminal 103 and the PC 104, to communicate with the image forming apparatus 101 on the network (LAN 100) via the AP 102. The PC 104 may be connected to the LAN 100 by wire, such as a LAN cable. In the present embodiment, as an example of the printing system, the above-described configuration is explained, but the configuration is not limited to this. What is required is that one or more information processing apparatuses and the printing apparatus are connected via a network so as to be capable of communication.

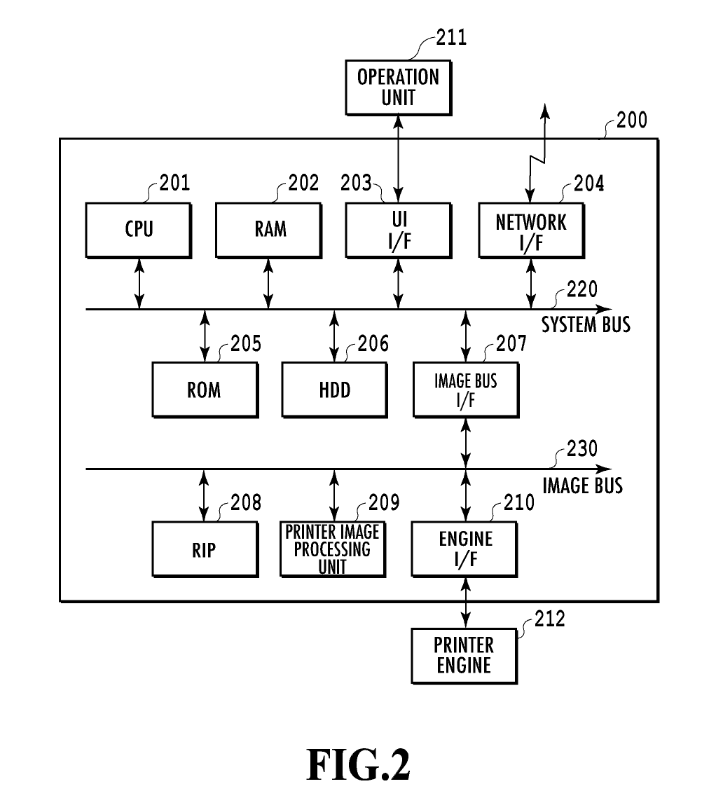

FIG. 2 is a block diagram showing a hardware configuration of the image forming apparatus 101 according to the embodiment of the present invention. To a System Bus 220, a CPU 201, a RAM 202, a UI I/F 203, a Network I/F 204, a ROM 205, and an HDD 206 are connected so as to be capable of communication with one another. Further, the component on the System Bus 220 accesses a RIP 208, a printer image processing unit 209, and a printing engine I/F 210 connected to an Image Bus 230 via an Image Bus I/F 207.

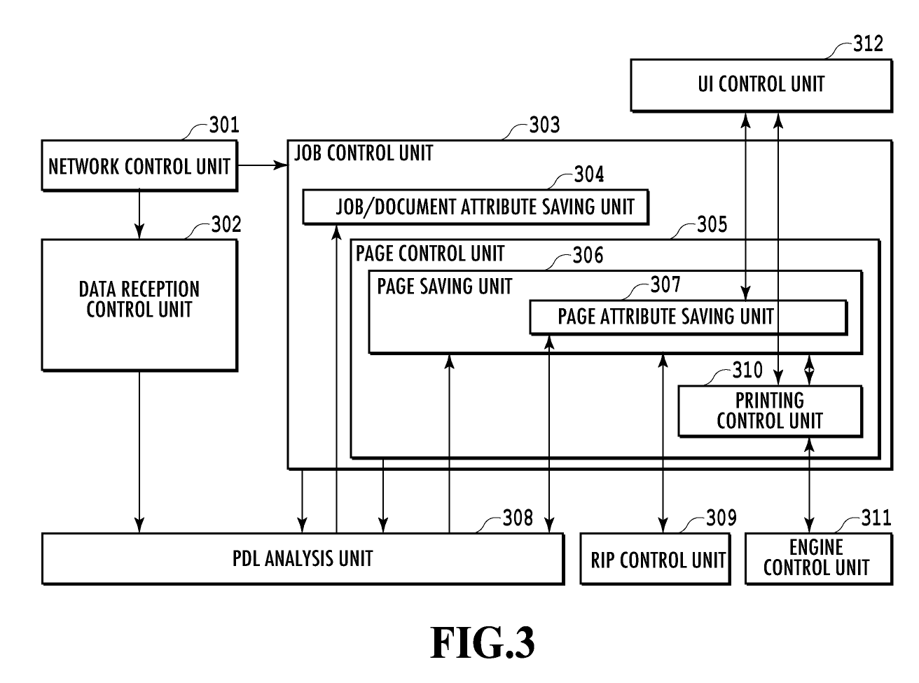

The CPU 201 is a central processing unit configured to control the entire image forming apparatus 101. The CPU 201 functions as each processing unit in FIG. 3, to be described later, by executing various pieces of software. The RAM (Random Access Memory) 202 stores temporary data being processed. The UI I/F 203 is connected to an input device 213 and notifies each module of a signal of the input device 213. The Network I/F 204 receives PDL data from the information processing apparatus (103/104) via the network and stores the PDL data in the HDD 206. The ROM (Read Only Memory) 205 stores various parameters and programs necessary to activate and operate the image forming apparatus 101 and is accessed by each software module in accordance with the necessity.

The HDD (Hard Disk Drive) 206 is used as a temporary storage of PDL data received via the network and accessed by each module as a data swap area of the RIP 208 and the printer image processing unit 209. The Image Bus I/F 207 is an interface that connects the System Bus 220 and the Image Bus 230 of the image forming apparatus 101. The Image Bus I/F 207 enables communication between the side of the System Bus 220 on which control-related software runs and the module relating to page image processing, which operates on the Image Bus 230.

The RIP (Raster Image Processor) 208 is connected to the Image Bus 230 and develops a PDL (Page Description Language) code into an image file. The printer image processing unit 209 performs resolution conversion and correction conversion suitable to a printer engine 212 for the image file generated by the RIP 208. The printer I/F 210 is a communication interface for the CPU 201 to controls the printer engine 212 and a finisher.

FIG. 3 is a diagram showing a software configuration of the image forming apparatus 101 according to the embodiment of the present invention and FIG. 3 shows each function of the image forming apparatus 101. A network control unit 301 receives print data from the information processing apparatus 103 or 104 and writes the print data to a data reception control unit 302, and then, receives a print job from the print data and registers the print job to a job control unit 303 as a print job (that is, job attribute information). The data reception control unit 302 buffers print data for each job.

The job control unit 303 includes a job/document attribute saving unit 304, a page control unit 305, and a printing control unit 310. The job/document attribute saving unit 304 saves job attribute information acquired from the network control unit 301. The job attribute information includes information on a sheet, such as “sheet size” and “sheet type”, in units of jobs and is overwritten by page attribute information in units of pages in accordance with the necessity.

The page control unit 305 is generated in units of pages by the job control unit 303 upon receipt of analysis results of a PDL analysis unit 308. Further, page attribute information generated by the PDL analysis unit 308 is sequentially associated with the page control unit 305. The page control unit 305 determines whether or not the page is the top page of the job and in the case where the page is the top page of the job, the page control unit 305 saves page attribute information on the top page in the job/document attribute saving unit 304 as document attribute information. For a page that lacks page attribute information, page information is supplemented by document attribute information.

The page control unit 305 includes a page saving unit 306 and further, the page saving unit 306 includes a page attribute saving unit 307. The page attribute saving unit 307 saves page attribute information on all the pages. Here, the page attribute information refers to information relating to the attributes of a sheet, such as “sheet size”, “sheet type”, and “paper feed tray”. The page control unit 305 selects an optimum paper feed mode based on the page attribute information saved in the page attribute saving unit 307. Further, the page control unit 305 functions as a paper feed possible/impossible determination unit of the present invention and in the case where it is not possible to determine an optimum paper feed mode, the page control unit 305 cancels the job or displays a setting screen so as to enable a user to supplement information relating to the sheet.

The PDL analysis unit 308 corresponds to a print data analysis unit of the present invention and reads print data from the data reception control unit 302 and performs analysis processing in accordance with analysis instructions from the job control unit 303. A RIP control unit 309 performs RIP processing. The printing control unit 310 acquires the image, for which RIP processing has been performed, from the page saving unit 306 and transfers the image to an engine control unit 311 after performing color separation into CMYK in accordance with instructions of the page control unit 305. Further, the printing control unit 310 accesses the page attribute saving unit 307 and determines the sheet size, the sheet type, and the paper feed tray of paper that is fed based on the job attribute information and the page attribute information. Upon receipt of image data for each of CMYK in units of pages from the printing control unit 310, the engine control unit 311 controls the printer engine to perform printing on each page after performing paper feed control. That is, the engine control unit 311 corresponds to a paper feed unit of the present invention. A UI control unit 312 controls a user interface that receives operations from a user.

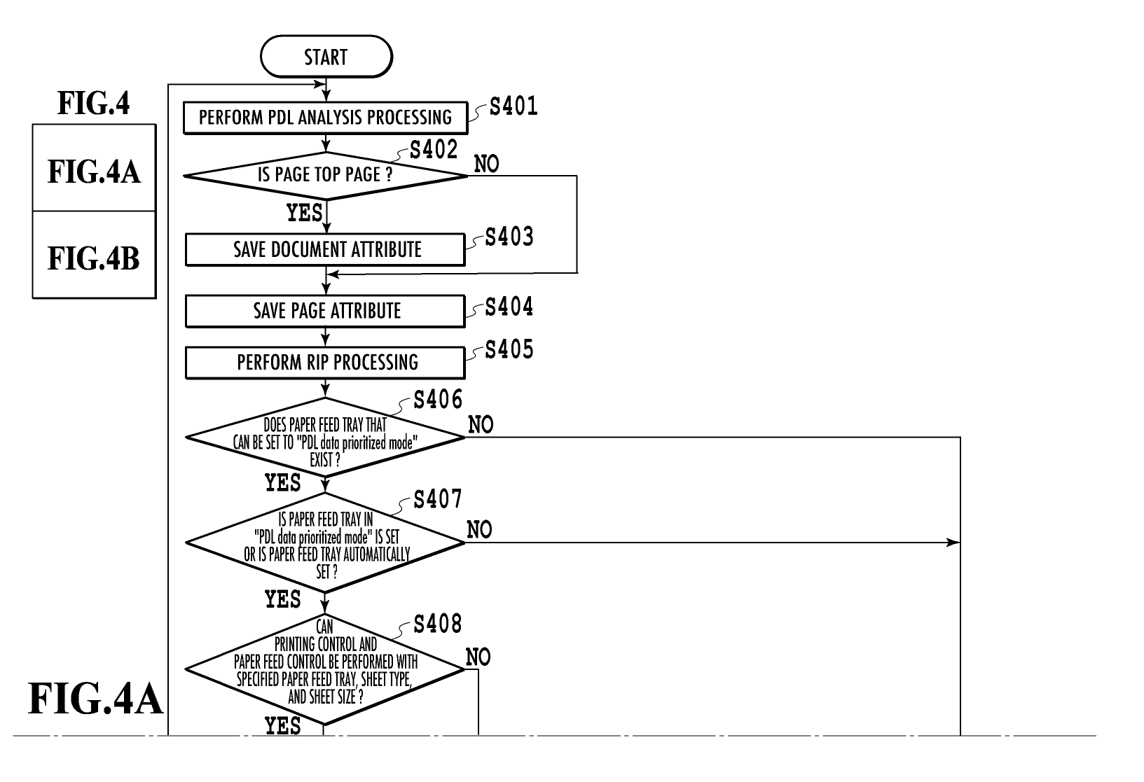

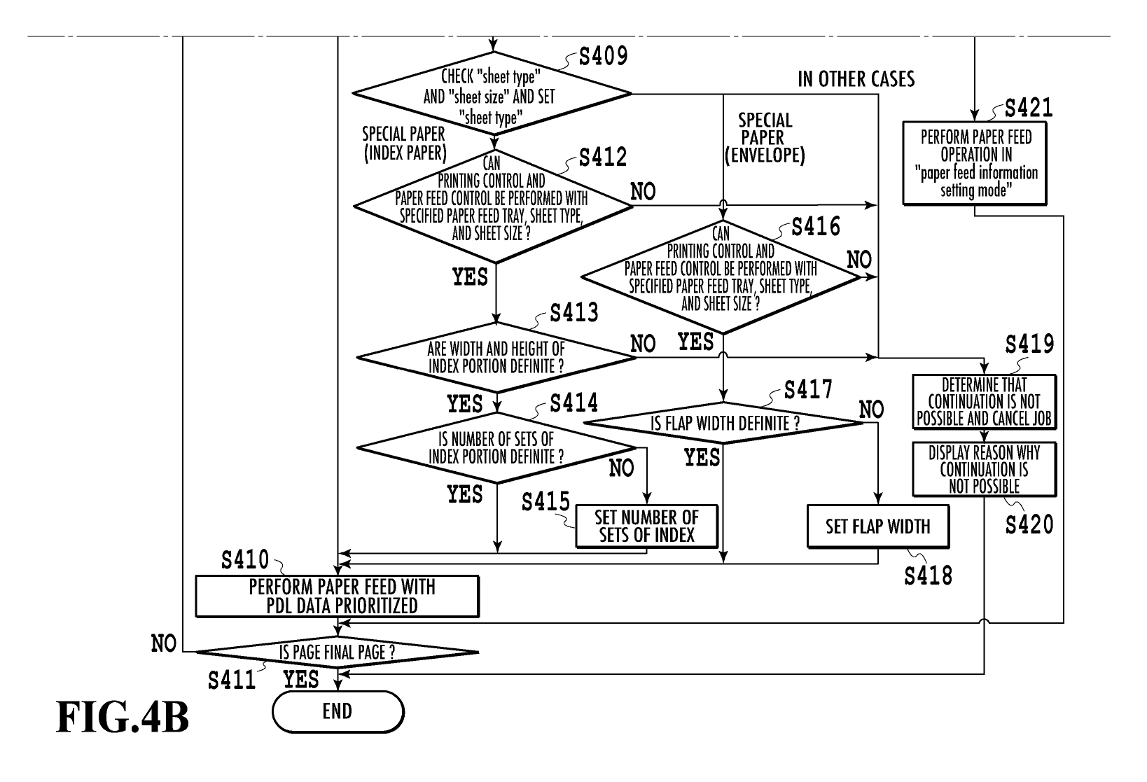

FIGS. 4A and 4B are flowcharts showing processing relating to paper feed and printing control of the image forming apparatus according to the embodiment of the present invention. In the case where the job control unit 303 instructs the PDL analysis unit 308 to analyze print data, the PDL analysis unit 308 reads print data from the data reception control unit 302 and analyzes the print data (that is, PDL data) (S401).

As described previously, upon receipt of the analysis results of the PDL analysis unit 308, the job control unit 303 generates the page control unit 305 in units of pages. Then, the page control unit 305 determines whether or not the page is the top page of the job (S402). In the case of determining that the page is the top page (S402 Yes), the page control unit 305 saves page attribute information on the top page in the job/document attribute saving unit 304 as document attribute information (S403). The page control unit 305 saves the page attribute information on all the pages in the page attribute saving unit 307 (S404). The page control unit 305 performs control so that the RIP control unit 309 performs RIP processing (S405).

In the case where RIP processing is performed, the page control unit 305 selects an optimum paper feed mode in accordance with the flowchart at step S406 to step S421 at the time of the printing control unit 310 determining and feeding a sheet that is used for printing. Here, step S406 to step S408 indicate the case where the operation is performed in “PDL data prioritized mode”. Further, step S409 and step S412 to step S418 indicate the case of “correction mode” in which “PDL data prioritized mode” is continued by a user supplementing paper feed parameters that cannot be acquired from PDL data by a panel operation. Furthermore, step S419 and step S420 indicate the case where it is determined that continuation of “PDL data prioritized mode” is difficult and the job is canceled. In addition, step S421 indicates the case of “paper feed information setting mode”, that is, the case where setting of the paper feed tray is performed always at the time of arranging a sheet that is fed.

The page control unit 305 checks whether the cassette that can be set to “PDL data prioritized mode”, that is, the cassette capable of performing paper feed control preferentially based on the print data exists in the cassettes of the image forming apparatus 101 (S406). In the case where it is possible to check the existence of the cassette for which “PDL data prioritized mode” is valid (S406 Yes), the page control unit 305 causes the processing to advance to step S407 and in the case where it is not possible to check the existence (S406 No), the page control unit 305 causes the processing to advance to step S421.

The page control unit 305 functions as a paper feed tray determination unit and determines whether or not it is possible to feed the page from the paper feed tray in “PDL data prioritized mode” (S407). That is, in the case where as the paper feed destination of the page, the paper feed tray in “PDL data prioritized mode” is specified, or in the case where the paper feed tray is automatically set (that is, in the case where there is a possibility that the paper feed tray in “PDL data prioritized mode” is selected as a result of automatic selection), the page control unit 305 causes the processing to advance to step S408. In the other case (S407 No), the page control unit 305 causes the processing to advance to step S421 and performs the paper feed operation in “paper feed information setting mode”.

In the case of determining that there is a possibility that the page is fed from the paper feed tray in “PDL data prioritized mode” (S407 Yes), the page control unit 305 determines whether or not it is possible to perform paper feed control from the page attribute information on the page (S408). That is, the page control unit 305 functions as a paper feed tray selection unit and determines the paper feed tray, which is the target of paper feed, from “paper feed tray”, “sheet type”, or “sheet size” and determines whether or not it is possible to perform paper feed control from the page attribute information on the page (that is, at least “sheet type” and “sheet size”). In the case of determining that it is possible to perform paper feed control (S408 Yes), the page control unit 305 causes the processing to advance to step S410 and performs paper feed control and printing control by the printing control unit 310 in accordance with the page attribute information (S410).

In the case of determining that it is not possible to perform paper feed control (S408 No), the page control unit 305 checks whether or not “sheet type” and “sheet size” are included in the page attribute information (S409). Then, on the condition that “sheet type” and “sheet size” are included in the page attribute information, the page control unit 305 causes the processing to branch according to “sheet type”. In the case where “sheet type” is special paper (index paper), the page control unit 305 causes the processing to branch to step S412 and in the case where “sheet type” is special paper (envelope), the page control unit 305 causes the processing to branch to step S416 (S408). In the other case, specifically, in the case where one of “sheet type” and “sheet size” is not included (that is, in the case where it is determined that continuation of the printing processing is not possible), the page control unit 305 cancels the job (S419). Next, the UI control unit 312 displays the reason to cancel the job on the user interface (S420).

In the case of causing the processing to advance by taking “sheet type” to be special paper (index paper), the page control unit 305 determines whether or not it is made possible to perform paper feed control from the page attribute information on the page by supplementing additional information (for example, number of sets of index paper and the like) (S412). That is, the page control unit 305 determines, based on the page attribute information on the page and the additional information, whether or not paper feed control is enabled in the paper feed tray selected from “paper feed tray”, “sheet type”, or “sheet size” of the page attribute information by supplementing the additional information.

In the case of determining that paper feed control is enabled (S412 Yes), the page control unit 305 determines whether or not the width and height of the index paper are definite at step S413 and whether or not the number of sets of the index paper is definite at step S414. In the case of determining that the width and height of the index paper are not definite at step S413 (S413 No), the page control unit 305 determines that continuation is not possible because printing will fail and causes the processing to advance to step S419. In the case of determining that the number of sets of the index paper is not definite at step S414 (S414 No), the page control unit 305 causes the processing to advance to step S410 after causing a user to input the number of sets of the index paper at step S415. That is, the page control unit 305 causes the processing to continue in “PDL data prioritized mode”. In the example shown in FIG. 4B, the specifications are determined so that continuation of the job is regarded as impossible without causing a user to input the width and height of the index paper in the case where it is determined that the width and height of the index paper are not definite, but it may also be possible to determine the specifications to be the same as those relating to the number of sets of the index paper. Consequently, in the case where the width and height of the index paper are not definite, it is also possible to cause the processing to continue in “PDL data prioritized mode” after causing a user to input the width and height of the index paper. In the case of determining that paper feed control is not enabled even by supplementing the additional information (S412 No), that is, in the case of determining that continuation of the printing processing is not possible, the page control unit 305 cancels the job (S419). Next, the UI control unit 312 displays the reason to cancel the job on the user interface (S420).

In the case of causing the processing advance by taking “sheet type” to be special paper (envelope), the page control unit 305 determines whether or not it is made possible to perform paper feed control from the page attribute information on the page by supplementing additional information (flap width) (S416). That is, the page control unit 305 determines, based on the page attribute information on the page and the additional information, whether or not paper feed control is enabled in the paper feed tray selected by “paper feed tray”, “sheet type”, or “sheet size” of the page attribute information by supplementing the additional information.

In the case of determining that paper feed control is enabled (S416 Yes), the page control unit 305 determines whether or not the flap width is definite at step S417. In the case of determining that the flap width is not definite at step S417 (S417 No), the page control unit 305 causes the processing to advance to step S410 after causing a user to input the flap width at step S418. That is, the page control unit 305 causes the processing to continue in “PDL data prioritized mode”. In the case of determining that paper feed control is not enabled even by supplementing the additional information (S416 No), that is, in the case of determining that it is not possible to cause the printing processing to continue, the page control unit 305 cancels the job (S419). Next, the UI control unit 312 displays the reason to cancel the job on the user interface (S420).

In the case of performing paper feed control and printing control by the printing control unit 310 in accordance with the page attribute information at step S410, the page control unit 305 makes an inquiry to the PDL analysis unit 308 and determines whether or not the page is the final page of the job (S411). In the case where the page is the final page of the job (S411 Yes), the image forming apparatus 101 terminates the processing in FIG. 4B and in the case where the page is not the final page of the job, that is, in the case where there is a page that follows (S411 No), the image forming apparatus 101 causes the processing to return to step S401.

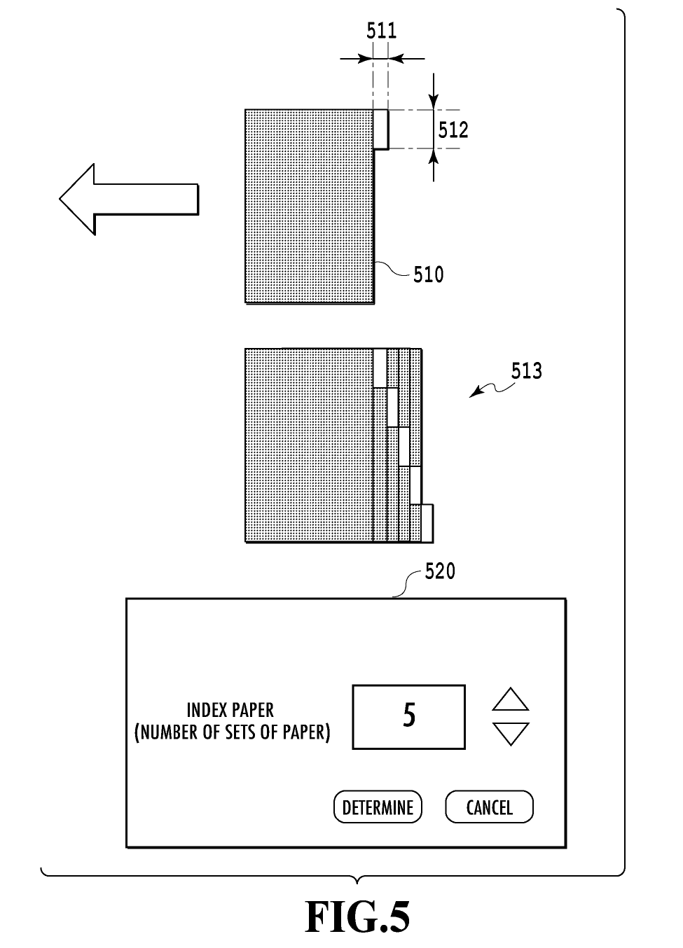

Next, by using FIG. 5 and FIG. 6, the special paper (for example, index paper, envelope) is explained, for which supplementary information is necessary to cause “PDL data prioritized mode” to continue. FIG. 5 is a diagram showing index paper that is fed to the image forming apparatus and the setting thereof.

Printing of index paper 510 includes a case where printing is performed on an index portion and a case where printing is not performed on the index portion and in the case where printing is not performed on the index portion, it is not possible to acquire information on a width (511) and a height (512) of the index portion from PDL data. Because of this, in the processing at step S413 in FIG. 4B described previously, the page control unit 305 determines that it is not possible to continue “PDL data prioritized mode” and the causes the processing to advance to step S419.

Here, for example, in the case where the sheet size is a size of a standard sheet, such as A4 and LTR, and the sheet type is index paper, the PDL data does not have size information on the index portion. On the other hand, in the case where the sheet size is a size of a sheet that is not a standard sheet and the sheet type is index paper, it is possible to determine that the PDL data has index information (the processing advances to S414).

Further, in a print job in which index paper is fed, a plurality of pieces of index paper is handled as one set in accordance with the number of divisions of the index portion. In FIG. 5, reference number 513 indicates index paper in the case where the number of sets is assumed to be “5” as an example.

Normally, the image forming apparatus 101 feeds the top index paper at the beginning of each job, and therefore, in the case where there is remaining index paper at the time of completion of the job, the image forming apparatus 101 discharges the index paper at a time and performs control so that the top index paper of the next set is fed. In order for the image forming apparatus 101 to perform control as described above, it is necessary for the image forming apparatus 101 to recognize in advance how many pieces of the index paper are included in one set. That is, it is necessary for a user to set the number of pieces of the index paper included in one set to the image forming apparatus 101.

Because of this, in “paper feed information setting mode”, in the case where a user arranges index paper, the image forming apparatus 101 displays a setting screen 520 in FIG. 5 and prompts a user to input the number of pieces of the index paper of one set. Further, also in “PDL data prioritized mode” (to be exact, “correction mode” in which “PDL data prioritized mode” is continued), at step S415 in FIG. 4B described previously, the image forming apparatus 101 displays the setting screen 520 and prompts a user to input the number of pieces of the index paper of one set. On the setting screen 520 in FIG. 5, an example is shown in which five pieces of the index paper are included in one set.

FIG. 6 is a diagram showing an envelope that is fed to the image forming apparatus and the setting thereof. In the case where printing is performed on an envelope 610, printing is performed in the state where the flap of the envelope 610 is open, but the print data described in PDLs does not include information on a flap width 611. Because of this, in the case where the image forming apparatus 101 is caused to operate in “PDL data prioritized mode”, as a parameter used for paper conveyance control, a value obtained by increasing the size of the envelope, which is acquired from the print data, by a size corresponding to the flap width 611 is necessary.

Because of this, in “paper feed information setting mode”, in the case where a user arranges the envelope 610, the image forming apparatus 101 displays a setting screen 620 and prompts a user to input the flap width 611 of the envelope 610. Further, also in “PDL data prioritized mode” (to be exact, “correction mode” in which “PDL data prioritized mode” is continued), at step S418 in FIG. 4B described previously, the image forming apparatus 101 displays the setting screen 620 and prompts a user to input the flap width 611 of the envelope 610.

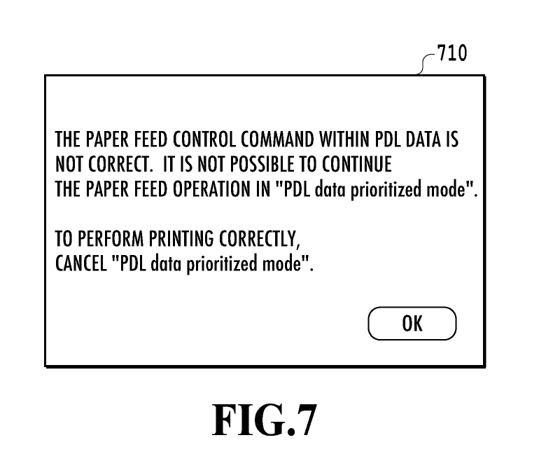

FIG. 7 is a diagram showing a printing processing cancel screen at the time of setting of “PDL data prioritized mode”. As described previously, in the case where the page control unit 305 determines that it is not possible to continue “PDL data prioritized mode” at step S419 in FIG. 4B, the UI control unit 312 causes the UI to display that the paper feed and printing processing are canceled internally at step S420 in FIG. 4B.

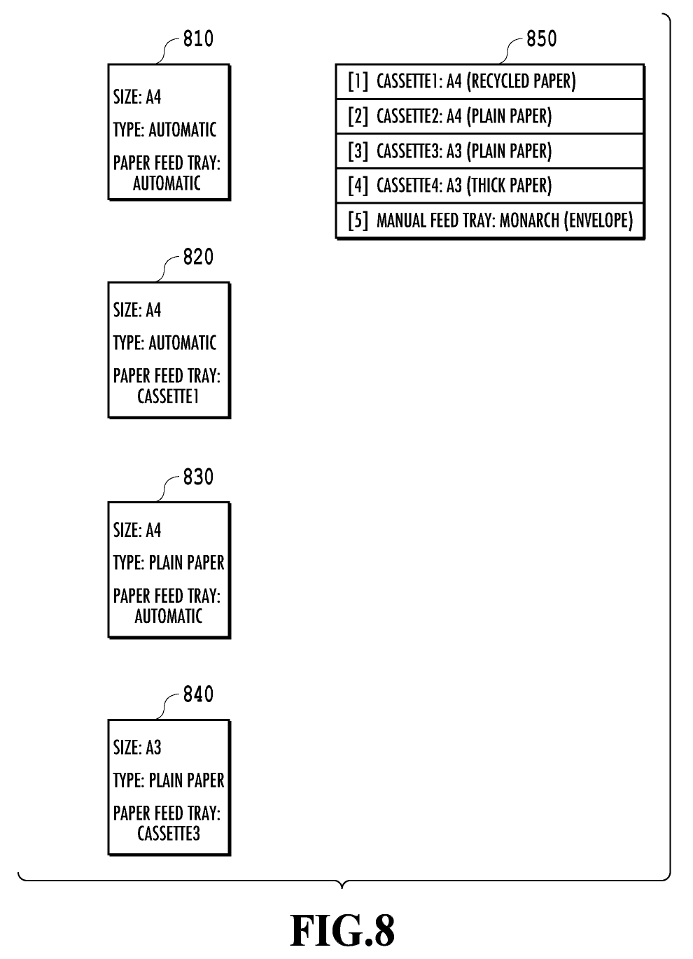

FIG. 8 is a diagram showing setting examples of a user on the paper feed setting screen of the information processing apparatus 103 or 104. As shown in FIG. 8, normally, a user sets one of four patterns 810 to 840 for the paper feed of print data. A setting example 810 is an example in which only the size of a sheet that is fed is set. A setting example 820 is an example in which the size and the paper feed destination of a sheet that is fed are set. A setting example 830 is an example in which the size and the sheet type of a sheet that is fed are set. A setting example 840 is an example in which the size, the sheet type, and the paper feed destination of a sheet that is fed are set.

In the setting example 810, only the sheet size is specified and the sheet type and the paper feed tray are set automatically, that is, optional. In this case, in the paper feed tray information setting mode, based on predetermined selection specifications, specifically, first, from the specified sheet size, cassette 1 and cassette 2 are selected as candidates and then, based on the selection priority and the number of remaining sheets in the paper feed tray, the paper feed tray is determined to be cassette 1. After this, the image forming apparatus 101 performs printing processing by supplementing the sheet type (that is, recycled paper) from information set to cassette 1. Further, in the case where “PDL data prioritized mode” is set in cassette 1 and cassette 2, which are selected as candidates from the sheet size, the image forming apparatus 101 cannot acquire the sheet type, and therefore, determines that it is not possible to continue the processing and cancels the job.

In the setting example 820, only the sheet size and the paper feed tray are specified and the sheet type is set automatically, that is, optional. In this case, in the paper feed tray information setting mode, the image forming apparatus 101 supplements the sheet type (that is, recycled paper) from information set to cassette 1, which is the specified paper feed tray. Further, in the case where “PDL data prioritized mode” is set in cassette 1, which is the specified paper feed tray, the image forming apparatus 101 cannot acquire the sheet type, and therefore, determines that it is not possible to continue the processing and cancels the job.

In the setting example 830, only the sheet size and the sheet type are specified and the paper feed tray is set automatically, that is, optional. In this case, in the paper feed tray information setting mode, the image forming apparatus 101 determines cassette 2 whose sheet size and sheet type coincide with the specified sheet size and sheet type to be the paper feed tray. In the case where there is a plurality of paper feed trays whose sheet size and sheet type coincide therewith, the paper feed tray is determined based on predetermined selection specifications (priority) and in the case where there is not a paper feed tray whose sheet size and sheet type coincide therewith, the job is canceled. Further, in the case where “PDL data prioritized mode” is set in cassette 2 whose sheet size and sheet type coincide therewith, the paper feed processing is performed with the sheet type of the PDL data. That is, the paper feed processing is performed in “PDL data prioritized mode”.

In the setting example 840, the sheet size, the sheet type, and the paper feed tray are specified. In this case, in the paper feed tray information setting mode, the paper feed processing is performed with the specified paper feed tray only in the case where all the parameters coincide with the specified parameters and in the case where even one of the parameters does not coincide therewith, the job (that is, paper feed processing) is canceled. Further, in “PDL data prioritized mode”, the paper feed processing is performed based on the sheet size, the sheet type, and the paper feed tray, which are set. That is, paper is fed from cassette 3.

As explained above, according to the image forming apparatus of the present invention, in the PDL data prioritized mode, even in the case where information necessary for paper feed is short within PDL data, it is possible to prevent printing from failing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-247845 filed Dec. 21, 2016, which is hereby incorporated by reference wherein in its entirety.

What is claimed is:

1. An image forming apparatus capable of performing, in accordance with reception of print data from an external device, image formation for a sheet that is set in a specific sheet set unit by using sheet attribute information added to the received print data without using sheet attribute information associated in advance with the specific sheet set unit, the image forming apparatus comprising:
one or more controllers including at least one processor or at least one circuit including a function, the one or more controllers being configured to function as:
a unit configured to prevent image formation in accordance with reception of print data from being performed based on that sheet attribute information added to the print data received from the external device is specific sheet attribute information.

2. The image forming apparatus according to claim 1, wherein
the controller further includes a unit configured to cancel, in accordance with reception of print data to which the specific sheet attribute information is added, printing registration of the print data.

3. The image forming apparatus according to claim 2, wherein
the unit configured to cancel causes a display device to display a reason to cancel printing registration of the print data.

4. The image forming apparatus according to claim 1, wherein
the controller further includes a unit configure to report so that an input of further sheet attribute information is prompted in accordance with reception of print data to which the specific sheet attribute information is added.

5. The image forming apparatus according to claim 4, wherein
the unit configured to report is a display device and the display device displays an input screen of further sheet attribute information.

6. The image forming apparatus according to claim 4, wherein
the specific sheet attribute information is information indicating special paper, and
the special paper is index paper or an envelope.

7. The image forming apparatus according to claim 6, wherein
the further sheet attribute information is information relating to a width and a height of the index paper and/or information relating to a number of sets of the index paper.

8. The image forming apparatus according to claim 6, wherein
the further sheet attribute information is a flap width of the envelope.

9. The image forming apparatus according to claim 1, wherein
the specific sheet set unit is a manual feed tray.

10. The image forming apparatus according to claim 1, wherein
the controller receives setting of one mode from a plurality of modes including at least a mode in which image formation for a sheet that is set in the specific sheet set unit is performed by using sheet attribute information added to the received print data without using sheet attribute information associated in advance with the specific sheet set unit.

11. The image forming apparatus according to claim 4, wherein
the controller cancels printing registration of print data without reporting to prompt an input of the further sheet attribute information in a case where setting for image formation is short other than the specific sheet attribute information despite that the sheet attribute information added to the print data received from the external device is the specific sheet attribute information.

12. A control method in an image forming apparatus capable of performing, in accordance with reception of print data from an external device, image formation for a sheet that is set in a specific sheet set unit by using sheet attribute information added to the received print data without using sheet attribute information associated in advance with the specific sheet set unit, the control method comprising:
a step of preventing image formation in accordance with reception of print data from being performed based on that sheet attribute information added to the print data received from the external device is specific sheet attribute information.

13. An image forming apparatus capable of performing, in accordance with reception of print data from an external device, image formation for a sheet that is set in a specific sheet set unit by using only setting information added to the received print data without using setting information registered in advance, the image forming apparatus comprising:
one or more controllers including at least one processor or at least one circuit including a function, the one or more controllers being configured to function as:
a unit configured to prevent image formation in accordance with reception of print data from being performed based on that an image forming method is not determined uniquely only by sheet attribute information added to the print data received from the external device.

14. A control method in an image forming apparatus capable of performing, in accordance with reception of print data from an external device, image formation for a sheet that is set in a specific sheet set unit by using only setting information added to the received print data without using setting information registered in advance, the control method comprising:
a step of preventing image formation in accordance with reception of print data from being performed based on that an image forming method is not determined uniquely only by sheet attribute information added to the print data received from the external device.
